(19) United States
(12) Patent Application Publication
(10) Pub. No.: US 2014/0109955 A1
(43) Pub. Date: Apr. 24, 2014

(54) PHOTOVOLTAIC PANEL PERGOLA WITH SLIDING MODULES

(71) Applicants: Andreas Chryssanthos Papanaklis, Pallini Attikis (GR); Sotirios Lachanas, Pallini Attikis (GR)

(72) Inventors: Andreas Chryssanthos Papanaklis, Pallini Attikis (GR); Sotirios Lachanas, Pallini Attikis (GR)

(21) Appl. No.: 14/131,557

(22) PCT Filed: Jun. 28, 2012
(86) PCT No.: PCT/GR2012/000026

§ 371 Date: Jan. 8, 2014

(30) Foreign Application Priority Data
Jul. 8, 2011 (GR) 20110100405

(51) Int. Cl. H01L 31/042

(52) U.S. Cl. CPC H02S 20/00
USPC 136/251

(57) ABSTRACT

This invention refers to a retractable pergola used for housing of domestic, commercial or industrial external sites. The pergola system consists of a fixed module (27), an outermost sliding module (24) and a number of intermediate sliding modules (23). The system is supported by special support carriers (43, 44) which also accommodate the electric motion system (28, 49, 50, 53, 54). All modules (23, 24, 27) are capable of hosting photovoltaic panels, thus offering the benefit of electricity production. The electric motion system is driven by an automation control system which incorporates light and wind sensors, so that the extension/tuck of the modules is performed automatically, making the user's presence unnecessary. Finally, the proposed solution seems ideal for domestic use in countries with high sunshine periods.

This invention refers to a retractable pergola, used in domestic, commercial or industrial applications.

A pergola is generally a metal or wooden structure covered on top by materials such as metal, wood, fabric, etc. and consists of fixed or retractable modules. When the upper part of a pergola consists of retractable parts, the pergola is characterized as retractable. The retractable parts are controlled by the user, either manually or automatically. Despite the progress that has been made concerning the automation control systems used on a pergola, much progress has yet to be made on finding new possibilities of use apart from shading external areas.

According to the above stated, the present invention's purpose is to create a retractable pergola which would combine the conventional use of a pergola as a means of shading an external site, with its special use as a means of producing electricity from commonly used photovoltaic panels. Furthermore, the application of an automation control system makes the user's presence unnecessary.

This invention accommodates special modules capable of bearing photovoltaic panels. The pergola system may consist of several modules, one of which is fixed, while the rest are capable of sliding. The system is supported by special support carriers which are connected with beams. The number of the system's modules depends on the number of support carriers and the durability of the structure's material. The motion mechanism comprises an electric motor, a winding metal armature and metal cables. These cables are applied to the outermost sliding module of the system. The sliding of that module results in the successive sliding of the intermediate sliding modules, as each intermediate sliding module forces its' adjacent module to slide. The direction of their movement is defined by appropriate guiding rails which are fitted to the support carriers. The extension/tuck of the modules is either manually controlled via a switch, or automatically via light and wind sensors. The electric wiring, which is essential for the operation of the photovoltaic generator and electric motion system, does not create any visual disturbance to the user.

According to the present invention, a photovoltaic panel pergola with sliding modules, has overall numerous advantages.

In particular, it is widely admitted that the installation of photovoltaic panels inevitably results in loss of space that could alternatively be used for other purposes. Thus, it is evident that the installation of photovoltaic panels on the special modules of the pergola mainly withdraws the previously stated disadvantage of conventional photovoltaic installations, while it ameliorates the energy efficiency of present and future buildings.

Furthermore, the pergola system embraces automation systems which aim not only at maximizing the electricity produced, but also at protecting the whole system against extreme weather conditions, without the users intervention. More specifically, during sunshine periods the light sensor forces the electric motor to move the modules in extended position so as to maximize electricity generation. The wind sensor is responsible for the protection of the pergola against heavy wind loads. In such cases, the electric motor is forced to move the modules in tucked position. During concurrent sunshine and fierce wind conditions, modules are forced to move in tucked position for safety reasons.

Finally, given the elegance of the pergola system, the proposed solution seems ideal for domestic use in countries with high sunshine periods.

The following description of the invention is based on an example and makes reference to the attached figures:

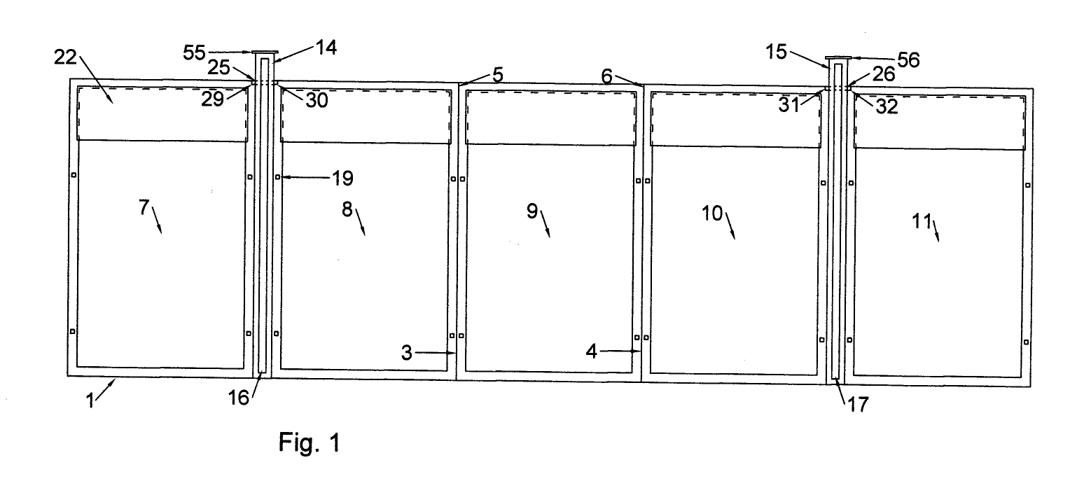

FIG. 1 shows an upper view of an intermediate sliding module capable of bearing five photovoltaic panels. The figure illustrates the bearing frames of the photovoltaic panels, the necessary holes for the panels' firm screwing, the holes needed for the electric wiring and the covers of the electric wiring, according to the present invention.

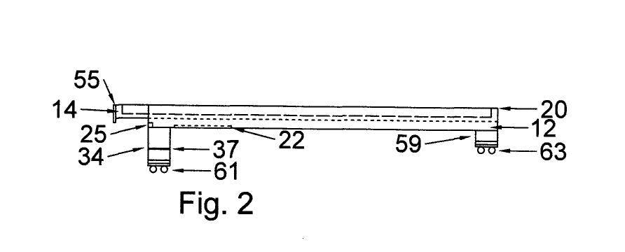

FIG. 2 shows a side view of an intermediate sliding module capable of bearing five photovoltaic panels. The figure illustrates the module's mounting rods together with their rollers, according to the present invention. These rollers, in conjunction with the guiding rails fitted to the support carriers, allow the pergola's modules to slide.

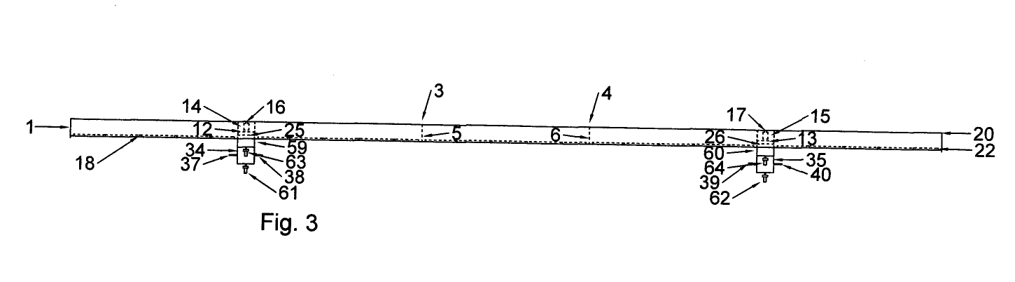

FIG. 3 shows a front view of an intermediate sliding module capable of bearing five photovoltaic panels. The figure illustrates the mounting points of the electric wiring chains and the water drainage holes, according to the present invention.

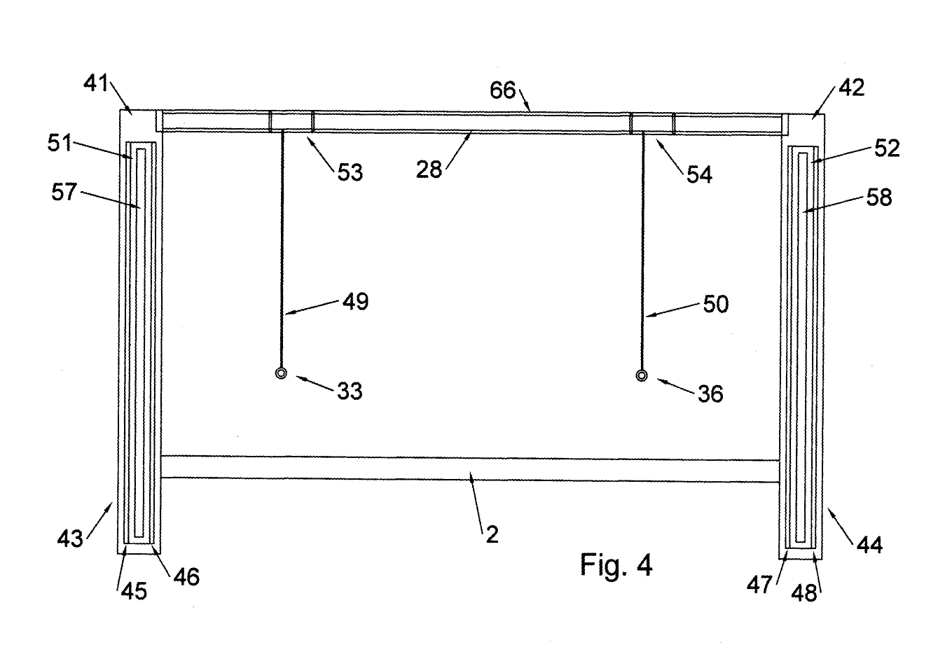

FIG. 4 shows an upper view of the supportive carriers and the electric motion system. The figure illustrates, the rollers' guiding rails fitted to the support carriers, the route channels of the electric wiring chains, the cable's winding armature and the cables for towing the outermost sliding module of the system, according to the present invention.

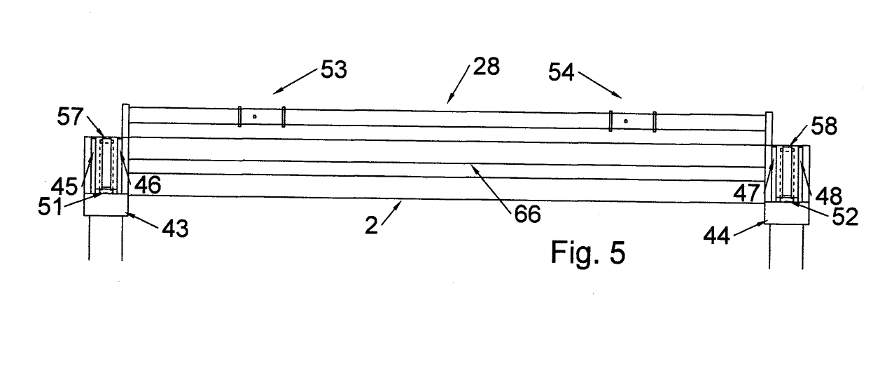

FIG. 5 shows a front view of the support carriers and the electric motion system. The figure illustrates further details concerning the rollers' guiding rails fitted to the support carriers, according to the present invention.

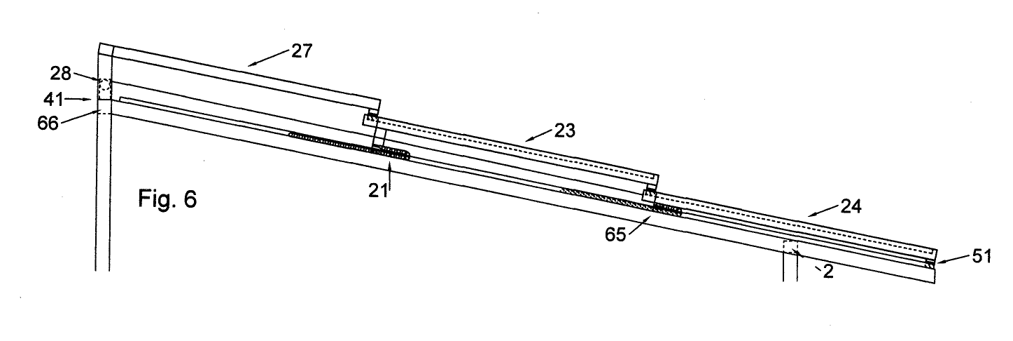

FIG. 6 shows a side view of the pergola. The figure illustrates the pergola in “extended position”, consisting of three modules capable of bearing photovoltaic panels, according to the present invention. The support carriers and the electric motion system are also visible.

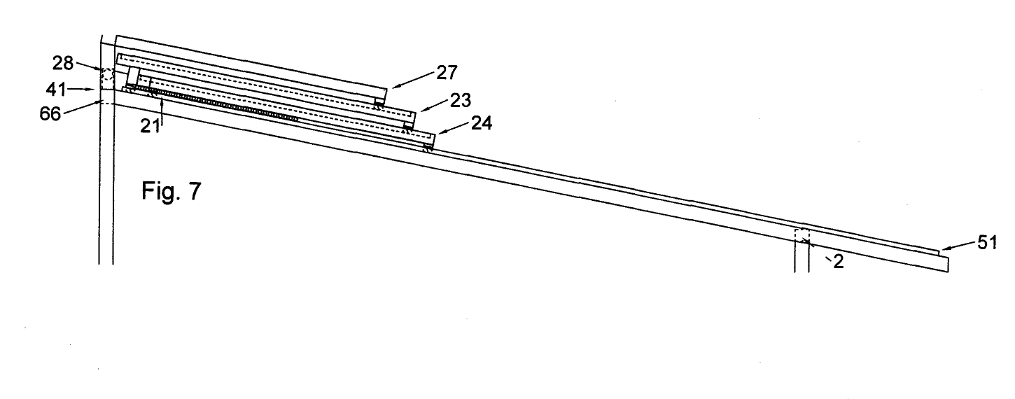

FIG. 7 shows a side view of the pergola. The figure illustrates the pergola in “tucked position”, consisting of three modules capable of bearing photovoltaic panels, according to the present invention. The support carriers and the electric motion system are also visible.

A sliding module is built using metal beams of cross section type “L” in the perimeter (1) and intermediate metal beams of cross section type “T” (3, 4). Thus, rectangular frames are formed (7, 8, 9, 10, 11), which are capable of bearing photovoltaic panels. Considering the statics of the module, beams of rectangular cross section type (12, 13) are inserted between several frames (7, 8, 10, 11). On the upper side of these beams (12, 13), guiding rails of cross section type “ [symbol] ”-inverted (14, 15) are fitted; the upper side of the guiding rails is narrowed (16, 17) so that the rollers inside them are prevented from getting out. Water drainage is achieved through the appropriate holes (18).

The holes at the bottom side of the module (19) are used for mounting the photovoltaic panels. In case of metal pergola structure, these holes are also used for the electric grounding of the photovoltaic panels. In addition to the mounting holes (19), packing pieces may optionally be used to assure that the upper surface of the photovoltaic panels matches exactly the upper surface of the module (20). A thin cover (22) is placed under the photovoltaic panel at each hosting frame (7) so that the junction boxes and the electric wiring are not visible. More specifically, transverse holes (25, 26) in both the metal beams of rectangular cross section type (12, 13) and the intermediate metal beams of cross section type “T” (5, 6) allow the routing of the panels' electric wires. On both sides of the beams (12, 13), holes (29, 30, 31, 32) allow the routing of electric wires along the mounting rods (34, 35) until they reach the corner-type fittings (37, 38, 39, 40), where the ends of the electric wiring chains (21, 65) are mounted.

The ends of the electric wiring chains are screwed at specific points of the electric wiring chains route channels (45, 46, 47, 48) so that the chains are free to move, allowing the pergola system to extend/tuck while the electric wiring between the retractable and the fixed part of the pergola remains hidden. The rollers' guiding rails (51, 52) are centrally fitted along each support carrier (43, 44), having their upper side narrowed (57, 58). Wiring chains route channels exist on both sides of a guiding rail, thus the present pergola implementation bears two support carriers with four route channels (45, 46, 47, 48).

The intermediate sliding module (23) has four mounting rods (34, 35, 59, 60). Each mounting rod features in its base a rolling mechanism (61, 62, 63, 64); the front pair of rollers (63, 64) is applied to the guiding rails (14, 15) of the adjacent sliding module (24), while the rear pair of rollers (61, 62) is applied to the support carriers' guiding rails (51, 52). As far as the outermost sliding module (24) is concerned, both pairs of rollers (61, 62, 63, 64) are applied to the support carriers' guiding rails (51, 52), meaning that the front mounting rods (59, 60) have the same length as the rear mounting rods (34, 35). The outermost fixed module features a rear pair of mounting rods (34, 35) firmly attached to specific points (41, 42) of the support carriers and a front pair of mounting rods (59, 60) with its rollers (63, 64) applied to the guiding rails (14, 15) of the intermediate sliding module (23).

An electric motor is responsible for the movement of the sliding modules. This motor is placed inside an armature (28). The ends of the towing cables (49, 50) are screwed at specific points of the armature's surface, while metal disks (53, 54) are responsible for defining the winding sectors of the cables. The other side ends (33, 36) of the towing cables are attached to the outermost sliding module (24). As the motor and armature rotate, the towing cables are winded around the armature's winding sectors, thus forcing the outermost sliding module to slide upwards.

Thereafter, a pair of specially designed pads (55, 56) fitted to the outermost sliding module (24), osculate the rear mounting rods (34, 35) of the intermediate sliding module (23). As a consequence, the intermediate sliding module (23) is forced to drift along the direction of movement of the outermost sliding module (24). The natural force of gravity in conjunction with the electric motor allow the modules to slide downwards. The above stated method describes how the pergola system switches from “extended” position to “tucked” position and vice versa.

1-10. (canceled)

11. A retractable photovoltaic panel pergola with sliding modules which comprises a fixed module, an outermost sliding module, a number of intermediate sliding modules supported by a structure of support carriers comprising of at least two supporting carriers extending in the direction of deployment of the pergola, guiding rails accommodating the rolling mechanisms of modules allowing for the movement of said modules in the direction of the deployment of the pergola, an electric motion system providing the capability for the extension/tucking of modules said electric motion system attached onto said structure of support carriers and is wherein the modules are divided into a plurality of rectangular frames each bearing a photovoltaic panel offering the potential of electricity production by inter connecting the photovoltaic panels by routing cables via transverse holes, as well as that the electric motion system is driven by an automation control system incorporating light and wind sensors, so that the extension/tuck of the modules is performed either manually controlled or automatically, wherein electric wire chains electrically connect said modules bearing connected photovoltaic panels and are free to move during extension/tuck of the modules, and the support carrier comprises a guiding rail having a wiring chain route channel for accommodating said electric wire chains; and
the photovoltaic panel pergola forms a means for producing electricity.

12. The photovoltaic panel pergola with sliding modules according to claim 11, wherein a sliding module comprises metal beams of cross section type “L” in the perimeter, intermediate metal beams of cross section type “T”, rectangular frames to bear the photovoltaic panels, a plurality of beams of rectangular cross section type, whose upper side bears guiding rails of cross section type “ [symbol] ”-inverted and narrowed at the upper side, water drainage holes and holes used for mounting, as well as electric grounding of the photovoltaic panels in case of a metal pergola structure.

13. The photovoltaic panel pergola with sliding modules according to claim 12, wherein a sliding module further comprises a thin cover at each rectangular frame, appropriate transverse holes in both the metal beams of rectangular cross section type and the intermediate metal beams of cross section type “T”, holes on both sides of the beams, one pad for each beam, one rear mounting rod and one front mounting rod for each beam, up to two corner-type fittings for each rear mounting rod and one electric wiring chain for each corner-type fitting.

14. The photovoltaic panel pergola with sliding modules according to claim 11, wherein the intermediate sliding module has a rolling mechanism at the base of each rear mounting rod which is applied to the respective support carriers guiding rail.

15. The photovoltaic panel pergola with sliding modules according to claim 11, wherein the intermediate sliding module, further comprises a rolling mechanism at the base of each front mounting rod, which is applied to the respective guiding rail of a thereunder adjacent sliding module.

16. The photovoltaic panel pergola with sliding modules according to claim 12, wherein the outermost sliding module comprises a rolling mechanism at the base of each rear mounting rod, a rolling mechanism at the base of each front mounting rod and, wherein both front and rear mounting rods are of equal length, and all rolling mechanisms are exclusively applied to the support carriers' guiding rails.

17. The photovoltaic panel pergola with sliding modules according to claim 12, wherein the fixed module comprises rear mounting rods firmly attached to a specific point of a support carrier and a rolling mechanism, at the base of each front mounting rod, which is applied to the respective guiding rail of a thereunder adjacent intermediate sliding module.

18. The photovoltaic panel pergola with sliding modules according to claim 11, wherein a structure of support carriers comprise support carriers and connective beams that differ in number and location, depending on the number and the weight of hosted photovoltaic panels.

19. The photovoltaic panel pergola with sliding modules according to claim 11, wherein the support carrier comprises a centrally fitted guiding rail with its upper side narrowed and a wiring chain route channel in each side of a guiding rail.

20. The photovoltaic panel pergola with sliding modules according to claim 11, wherein the electric motion system comprises an electric motor placed inside an armature, metal disks that define the winding sectors of towing cables and special components used for attaching towing cables to an outermost sliding module.
